(19) United States
(12) Patent Application Publication
(10) Pub. No.: US 2009/0194487 A1
(43) Pub. Date: Aug. 6, 2009

(54) METHOD AND INSTALLATION FOR PACKAGING MUDS BEFORE DRYING

(75) Inventors: Claude Prevot, Velizy (FR); Marcel Lesoille, Bougival (FR); Andre Haubry, Mezy Sur Siene (FR)

Correspondence Address: CONNOLLY BOVE LODGE & HUTZ LLP, 1875 EYE STREET, N.W., SUITE 1100, WASHINGTON, DC, 20006, US

(73) Assignee: DEGREMONT, Rueil-Malmaison (FR)

(21) Appl. No.: 12/376,149

(22) PCT Filed: Aug. 6, 2007
(86) PCT No.: PCT/FR2007/001347

§ 371 Date: Feb. 27, 2009

(30) Foreign Application Priority Data
Aug. 8, 2006 (FR) 06 07221

(51) Int. Cl. C02F 11/14; C02F 1/66; C02F 1/52

(52) U.S. Cl. 210/766; 210/198.1

(57) ABSTRACT

Method for packaging liquid muds resulting from the treatment of urban and/or industrial waste water according to which the mud is subjected to a mechanical dehydration step followed by a thermal drying step. Ferric chloride and/or quicklime or slaked lime is injected into the mud after the dehydration step and before the drying step or at the beginning of the drying step.

The invention relates to a process for conditioning liquid sludges originating from a municipal and/or industrial wastewater treatment according to which the sludges are subjected to a mechanical dewatering step followed by a heat drying step.

The treatment train for sludges originating from the purification of municipal and/or industrial wastewaters has changed over time.

More than ten years ago now the treatment of sludges stopped after mechanical dewatering leading to a degree of dryness of around 20%. The sludges thus thickened could be used in agriculture or be discharged to landfill.

The use of ferric chloride as a coagulant is widely employed in liquid sludges before mechanical dewatering.

Similarly, the post-liming of dewatered sludges is also known and widely used for the purpose of stabilizing them and structuring them either for dumping or for agricultural benefit.

In recent years the final destination of sludges from municipal and/or industrial water purification plants has experienced significant changes. The dumping of sludges is no longer a favored route since landfills will eventually only be able to receive what is known as ultimate waste (European directive 1999/31/EC of 26 Apr. 1999). The exploitation in agriculture of liquid or dewatered sludges must face up to a more restrictive standardization due to pollution risks linked to the presence of heavy metals and/or organic molecules capable of causing health problems. The development of direct incineration has neither compensated for the increase in sludge production nor the limitations on dumping and agricultural exploitation.

For these reasons, the heat drying technologies applied to dewatered sludges have experienced a significant industrialization and a large number of drying units have been established either directly at the purification plants, or in the dedicated collection and treatment centers.

The sludge treatment train completed by heat drying makes it possible to provoke the evaporation of the water in the dryers and to obtain a high degree of dryness, preferably greater than 90%.

Heat drying makes it possible to limit the volumes and to produce a dried sludge more suitable for energy recovery (higher calorific value) and for agricultural exploitation (complete sterilization of the product).

Heat drying leads to a consumption of energy, but substantial advantages result therefrom. The sludges after drying are in the form of granules, of reduced volume. The pathogenic germs have been killed. The sludges thus treated may be approved as products that are particularly advantageous for agriculture.

In such a treatment train comprising a drying step after the dewatering step, the stabilization and structuring of the sludges result from the drying itself so that there is no longer any reason to use lime, as was the case when the treatment stopped with the dewatering and was not followed by drying.

Much feedback stemming from heat drying units however highlights difficulties of various natures but most particularly the varying capacity of the water to be evaporated depending on the design of the water treatment line, and also problems of high viscosity after dewatering.

The evaporative capacity of a dryer is the amount of water that it can evaporate per hour; it depends on the installed power and characteristics of the dryer. For indirect dryers (the thermal fluid is not in direct contact with the sludge), it is customary to express this evaporative capacity in kg of water evaporated per hour and per m² of drying area; it is around 20 kg/m².h for a sludge that is easy to dry (example: organic sludge of prolonged aeration), it is only 15 kg/m².h for more difficult sludges (example: primary sludges), or even 13 kg/m².h for sticky sludges from mixtures of municipal and industrial effluents. The drop in the evaporative capacity naturally has an impact on the thermal efficiency of the dryer and on the energy consumption which is around 1 kWh for evaporating one kg of water under normal conditions.

For example, it has been shown that an exclusively biological sludge produced by prolonged aeration behaves differently to a heavily loaded activated sludge and that this heavily loaded activated sludge itself also has, depending on its age, variable properties.

This evaporative capacity is directly connected to the characteristics of the dryer, and to the energy consumption required to be used to compensate for the endothermicity of the evaporation reactions. Despite the applications to digested sludges with reuse of the biogas produced, the endothermicity of the reactions is covered by the use of a high-quality fuel posing the general problem of sustainable development.

More particularly, when the municipal effluents are mixed with a significant proportion of industrial effluents, a significant change in the evaporative capacity of the sludges generated by the treatment of these effluents has been demonstrated.

This change is more or less pronounced depending on the presence of certain complex mineral or organic molecules that originate from the industrial effluent. These molecules cover a very wide spectrum ranging from aliphatic carbon-based structures to aromatic derivatives of the family of benzene and polyphenols including all derivatives of carboxylic acids. The presence of mineral fillers in the industrial effluents may also strongly influence the free water/bound water distribution of a sludge.

This change in the evaporative capacity, in addition to it inducing a larger consumption of high-quality energy and a longer drying time, has repercussions on the mechanical behavior of the drying process.

Furthermore, it is known that an organic sludge that is heat dried in a range of dryness that makes it possible to move from 20% to 90% passes through different rheology steps including, in particular, what is known as a plastic phase characterized by clogging properties and high shear strengths. Generally, the plastic phase appears when the dryness is between 45 and 55%.

The drying technologies applied industrially use either a drying that is applied directly to the dewatered sludge, in which case the dryer must mechanically withstand the appearance of the plastic phase, or a drying applied to a reconstituted sludge. This reconstituted sludge is a mixture of dewatered sludges and dried sludges that enables the reconstituted sludge to have a dryness beyond the plastic rheology. In this case, it is the equipment upstream of the dryer that must ensure the correct conditioning of the reconstituted sludge and thus ensure an optimal functioning of the dryer.

For these various reasons, the drying units that treat, in particular, mixtures of municipal and industrial sludges have exploitation difficulties that lead to overconsumptions of high-quality energy, a lower degree of reliability due to the mechanical problems encountered and consequently operating costs which may pose the problem of the merit of the treatment line.

The objective of the invention is, above all, to provide a process for conditioning sludges with a view to heat drying after mechanical dewatering, which no longer has, or has to a lesser degree, the drawbacks explained above. It is desired, in particular, to avoid a reduction in the evaporative capacity of the sludges entering the dryer and, preferably, to also avoid an increase in the viscosity of the sludges.

Surprisingly, it has been found that, in a treatment train comprising a dewatering step followed by a heat drying step in a dryer, the addition of ferric chloride and/or quicklime or slaked lime into the sludges after dewatering and before drying produces two unexpected results, different from the results known for these products, namely:
eliminating, or at the very least reducing, the problems of bonding of the sludges in the dryer, while maintaining the viscosity of the sludges, without substantial increase;
maintaining, or even increasing, the evaporative capacity.

The subject of the invention therefore lies in the injection of reactants at points located between the mechanical dewatering of the sludges and the heat drying of the latter. These controlled injections of reactants make it possible to inhibit any reaction which may, on the one hand, lead to an inappropriate and detrimental change in the rheology of the sludges and, on the other hand, reduce the evaporative capacity of the water from the sludges.

According to the invention, a process for conditioning liquid sludges originating from a municipal and/or industrial wastewater treatment according to which the sludges are made to undergo a mechanical dewatering step followed by a heat drying step, is characterized in that ferric chloride and/or quicklime or slaked lime are injected into the sludge between the dewatering step and the drying step and/or at the inlet to the drying step, so that the bonding of the sludges during the drying step is reduced and the evaporative capacity is improved.

The injected dose of ferric chloride is advantageously between 1 and 10% by weight relative to the solids content of the sludge. The optimum injected dose of ferric chloride may be determined by observation of the dewatered sludge obtained which should not be compact and should give a satisfactory result in the bonding test on “filtering textile media”, explained at the end of the description.

Preferably, the injected dose of quicklime or slaked lime is between 5 and 30% by weight relative to the solids content of the sludge.

The injection of lime is advantageously carried out in the form of powder so as to form a coating of the sludge cake, without excessive mixing in order to prevent any thixotropic reaction. The lime powder may be injected just before the drying step or at the beginning of the drying step.

The invention also relates to an installation for conditioning liquid sludges for the implementation of the process defined previously, comprising mechanical dewatering means followed by a heat dryer, and characterized in that it comprises, between the mechanical dewatering means and the heat dryer, and/or at the inlet to the heat dryer, means for injecting ferric chloride, and/or means for injecting quicklime or slaked lime over the sludge.

Preferably, the means for injecting quicklime or slaked lime are provided in order to ensure a spraying of quicklime or slaked lime over the sludge.

The injection of lime is carried out so as to form a coating of the sludge cake with the lime powder.

Apart from the arrangements disclosed above, the invention consists of a certain number of other arrangements which will be described more explicitly hereinafter in terms of an exemplary embodiment described with reference to the appended drawing, but which is in no way limiting. On this drawing:

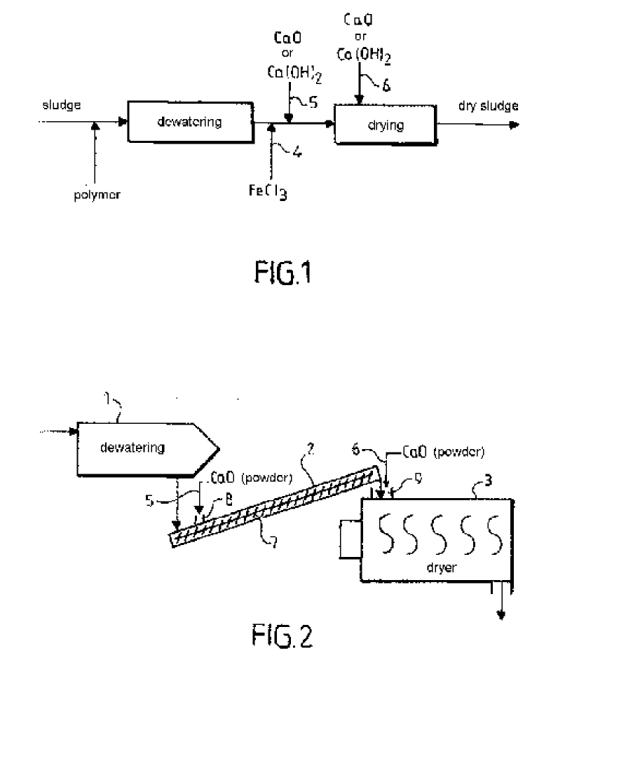

FIG. 1 is a scheme of a process for conditioning sludges according to the invention; and

FIG. 2 schematically illustrates the dewatering and drying installation.

Referring to FIG. 1 of the drawing, it can be seen that the liquid sludge to be treated arrives, from the left according to the scheme, at the mechanical dewatering step. An injection of polymer into the sludge may be carried out before dewatering.

Various devices such as belt filters, filter presses or centrifuges may be used for the mechanical dewatering. According to the representation in FIG. 2, a centrifuge 1 is provided for this step.

On exiting the dewatering step, the sludges form a sort of paste, the degree of dryness of which may be around 20%. The dewatered sludges are then conveyed via a transporting device 2 (FIG. 2) to a dryer 3 in order to be subjected to a heat drying which may take the degree of dryness to 90% and above.

It has been observed that for certain sludges, especially sludges that result from mixtures of municipal and/or industrial wastewaters, the sludges have a high viscosity, which leads to an increase in problems of bonding in the dryer. Moreover, this increase in viscosity is accompanied by a drop in the evaporative capacity.

The result of this is, with this type of sludge that is particularly difficult to treat, the drying capacity decreases, sometimes even leading to a complete blockage of the dryer.

Surprisingly, it has been found that the addition of ferric chloride and/or quicklime or slaked lime in the sludges after dewatering and before drying, and/or at the inlet of the dryer 3, produces two unexpected results, different from the results known for these products, namely:
eliminating, or at the very least reducing, the problems of bonding of the sludges in the dryer, while maintaining the viscosity of the sludges, without substantial increase;
maintaining the evaporative capacity, without a substantial drop, or even increasing this evaporative capacity.

According to the invention, ferric chloride (FeCl₃) in solution and/or quicklime (CaO) or slaked lime (Ca(OH)₂) in powder form are injected into the sludge after the dewatering step and before the drying step and/or at the inlet to the drying step.

A first injection of a solution of ferric chloride into the sludges after mechanical dewatering may prove necessary in some cases. Means 4 for injecting the ferric chloride are represented schematically in FIG. 1 at the outlet from the dewatering step. The dose is from 1 to 10% by weight of FeCl₃ relative to the solids contained in the sludge. The optimum dose is determined by observation of the dewatered sludge obtained. The latter must not be compact and must give a satisfactory result in the test of bonding to “filtering textile media” explained at the end of the description. An injection of ferric chloride solution may also be carried out at the inlet to the dryer 3.

This step does not necessarily correspond to the search for the optimum dryness that it is possible to obtain by mechanical dewatering. It also requires the adaptation of the polymer suitable for the dose of ferric chloride necessary to obtain a favorable “filtering textile media” test.

A second injection consists in adding a certain proportion of quicklime or slaked lime into the dewatered sludge, just before introducing the latter into the drying unit, or even into the dryer itself depending on the drying technology used. This introduction must therefore be carried out after any intermediate storage operation of the dewatered sludge conditioned as explained above. Means 5, 6 for injecting the lime are represented schematically respectively before the introduction of the sludge into the drying unit, and in the drying unit.

In addition, this injection must not use forced mechanical stirring in order to avoid the known phenomena of liquefaction caused during the addition of lime into an organic sludge.

The injection method consists in coating the sludge cake without seeking to obtain an intimate mixture. This is why it is carried out either by the introduction of the lime powder into a mixer/transporter 2 (FIG. 2), for example a screw mixer 7, that feeds the dryer, or by direct addition into the dryer 3 (FIG. 2) (the case, for example, for indirect dryers of the disc or blade type), or in the hopper for force-feeding the feed pump (the case, for example, for thin-film dryers), or in a mixer/transporter that ensures the production of the reconstituted sludge (the case, for example, for drum dryers and belt dryers).

The dose of lime to be injected depends on the type of sludge to be treated, varying, in particular, as a function of the amount of industrial effluents present in the raw water. It lies within the range of 5 to 30% by weight relative to the solids contained in the sludge.

The addition of lime is carried out in the form of powder by coating the sludge via sprinkling between the dewatering and drying or at the inlet to the drying. The surface of the sludge cake is coated with lime powder.

Mixing of the lime and the sludge, which would destroy the sludge and would lead to the thixotropy phenomenon is absolutely avoided.

The coating of the sludge with the powder may be carried out either at the screw 7 (FIG. 2) which conveys the powder to the drying step, via a shower of lime powder at the inlet 8 of this screw, or via a shower of lime powder at the inlet 9 (FIG. 2) of the heat dryer. The screw 7 provides the transport of the sludge exiting the mechanical dewatering device 1 up to the inlet 9 of the dryer 3. At the outlet of the dryer the sludges are sterilized, after having undergone a heat treatment generally at 105° C. for around 2 h; moreover, they are biologically stabilized and do not ferment.

During pilot trials for adjusting the process, it was observed that the combining of two injections carried out as described caused both a substantial increase in the evaporative capacity (between 40 and 60%) and also a complete modification of the rheology of the sludge, completely inhibiting the appearance of bonding and agglomerating phenomena.

These surprising effects appear to be linked both to the disintegration of the dewatered sludge due to the use of FeCl₃ (reduction in the average size of the conditioned sludge particles), to the exothermic reaction inside the dryer caused by the reaction of the quicklime with the free water at the surface of the sludge while drying and to the increase in the pH with the quicklime or slaked lime.

Together, these additions of chemical reactants are the basis of the phenomena listed below:
inhibition of the decomposition of certain organic compounds;
modification of the surface appearance of the sludge in contact with the hot walls of the dryer and/or with the hot air which may be used as a heat transfer fluid;
modification of the pH of the sludge inhibiting certain chemical reactions;
use of the fluidifying properties of the lime particles.

As already indicated, the determination of the optimum dose of ferric chloride is carried out by observation of the dewatered sludge obtained which must not be compact and must give a satisfactory result in the test of bonding to “filtering textile media” explained hereinbelow.

### TEST OF BONDING TO “FILTERING TEXTILE MEDIA”

This laboratory methodology, applicable to all sludges, makes it possible to observe the detachment of the sludge cake on a cloth: the “non-compact” appearance of the cake and the lack of adherence of the latter to the cloth denote a “non-bonding” cake. A “non-bonding” cake is one of the parameters required for the characterization of the sludge for good operation of the drying plant.

A) Measurement Principle

the sludges are first flocculated by the most suitable reactant or reactants, that is to say those providing a very strong granular floc, with release of a maximum of interstitial liquid and this at minimal dosages;

the flocculated sludges are then drained;

the drained, and therefore thickened, sludges are compacted in order to:

a) eliminate as much free air as possible;

b) observe the adherence to the filtering medium of the compacted sludge (aptitude for clogging, therefore for bonding);

the sludges thus compacted are placed on a “dish towel” and enveloped in the latter in order to be wrung out by hand for 5 min. During the wringing out, it is necessary to knead “the envelope” in order to remove as much water as possible.

B) Apparatus

For Draining

600 μm laboratory sieve (stainless steel sieve Ø: 200 mm and H: 50 mm having a wire gauze with a square-opening mesh);

a scraper (L: 100 mm×w: 50 mm);

For Compacting

a 1 l plastic beaker;

For the “kneading ⊕ wringing”

a rectangle of cotton cloth (thick and strong “hand towel” type) (L: 100 cm×w: 25 cm).

C) Procedure

1. Sample to be treated

minimum 10 l of sludge

to characterize the sludge:

MES (g/l)—solids content (%)—pH Volatile solids (105-550° C.)=% /MS

2. “Filtering textile media” test or “dish towel” test

For each test, after having chosen the most appropriate reactant or reactants, the sludge sample withdrawn will be 500 ml;

it will be necessary, successively after flocculation:

a) to pour all of the flocculated sludge into the center of the sieve.

To observe and note the drainage rate: the interstitial liquid should migrate rapidly into the flocs.

b) using the metal scraper, “roll” the heap of sludge drained over the mesh or over the sieve to wring out the sludge as much as possible.

Observe the appearance of the floc: the floc should be granular.

It is necessary to avoid large “fatty” flocs and flocs that are too fine.

c) using the 1 1 plastic beaker, press all the drained sludge present on the sieve. Observe the amplitude of the lateral creep of the sludge: the amplitude of the creep should be low and depends on the mechanical resistance of the floc to the pressure. Furthermore, the “compacted sludge cake” formed must remain on the filtering medium, or on the base of the plastic beaker at the end of this step (the cake must not be split in two);

d) using the scraper, detach the “compacted sludge cake” from its support. Observe the adhesion to the sieve of the compacted sludge (clogging ability) the clogging should be low;

e) pour half of the volume of the compacted sludges produced onto the “dish towel”;

fold the edges of the latter over the sludge, in order to produce a leaktight “envelope” to prevent possible leaks during the “kneading wringing” phase;

simultaneously knead and wring out the “envelope” for 5 min;

f) open the “envelope” and observe the detachment of the final cake obtained from the cotton cloth used; the cake, of “non-compact” appearance, should detach under its own weight from the cloth with little adherence to the cloth; the expression “detach under its own weight” should be understood to mean that the cake detaches from the cloth when this cloth is positioned in a vertical plane;

g) calculate the dryness of the cake.

D) Interpretation of the results

A “non-bonding” cake is one of the parameters necessary for the correct operation of the drying plant. This test makes it possible, depending on the physical condition, appearance and behavior of the final cake on the filtering medium:

a) to make provision for the reactant or reactants;

b) to optimize the doses of the reactants;

to be used in the sludge to obtain a “non-bonding” cake.

1. A process for conditioning liquid sludges originating from a municipal and/or industrial wastewater treatment according to which the sludges are made to undergo a mechanical dewatering step followed by a heat drying step, wherein ferric chloride and/or quicklime or slaked lime are injected into the sludge between the dewatering step and the drying step and/or at the inlet to the drying step, so that the bonding of the sludges during the drying step is reduced and the evaporative capacity is improved.

2. The process as claimed in claim 1, wherein the injected dose of ferric chloride is between 1 and 10% by weight relative to the solids content of the sludge.

3. The process as claimed in claim 1, wherein the optimum injected dose of ferric chloride is determined by observation of the dewatered sludge obtained which should not be compact and should give a satisfactory result in the bonding test on “filtering textile media”.

4. The process as claimed in one of claims 1, wherein the injected dose of quicklime or slaked lime is between 5 and 30% by weight relative to the solids content of the sludge.

5. The process as claimed in claim 1, wherein the injection of lime is carried out in the form of powder so as to form a coating of the sludge cake, without excessive mixing in order to prevent any thixotropic reaction.

6. The process as claimed in claim 5, wherein the lime powder is injected just before the drying step.

7. The process as claimed in claim 5, wherein the lime powder is injected at the beginning of the drying step.

8. An installation for conditioning liquid sludges for the implementation of the process as claimed in claim 1, comprising mechanical dewatering means followed by a heat dryer, wherein it comprises, between the mechanical dewatering means (1) and the heat dryer (3), and/or at the inlet to the heat dryer (3), means (4) for injecting ferric chloride, and/or means (8,9) for injecting quicklime or slaked lime over the sludge.

9. The installation as claimed in claim 8, wherein the means (8,9) for injecting quicklime or slaked lime over the sludge are provided in order to ensure a spraying of quicklime or slaked lime over the sludge.
